(19) United States
(12) Patent Application Publication
(10) Pub. No.: US 2006/0005035 A1
(43) Pub. Date: Jan. 5, 2006

(54) Keystroke input device for use with an RFID tag and user verification system

(76) Inventor: Michael E. Coughlin, Mission Hills, KS (US)

Correspondence Address: Hovey Williams LLP, Suite 400, 2405 Grand Blvd., Kansas City, MO, 64108, US

(21) Appl. No.: 10/961,953

(22) Filed: Oct. 8, 2004

Related U.S. Application Data
(60) Provisional application No. 60/582,252, filed on Jun. 22, 2004.
(60) Provisional application No. 60/583,582, filed on Jun. 28, 2004.

(51) Int. Cl. G06F 15/177

(52) U.S. Cl. 713/182

(57) ABSTRACT

A keystroke input device (10) for use with an RFID tag and user verification system connects to a keyboard (12) and to a host computer (14). The device (10) includes an antenna (22) for receiving an identification signal from the RF identification tag worn by a user, wherein the device (10) generates a login script including the user's username and password, and communicates the login script to the host computer (14) to log the user into the computer (14). The device (10) includes a network port (28) for enabling communications between the device (10) and a computer network, wherein the device (10) generates the login script by submitting an identification number to a remote identification server via the network port (28) and receiving the login script from the remote identification server.

### RELATED APPLICATIONS

The present application is a nonprovisional patent application and claims priority benefit, with regard to all common subject matter, of earlier-filed U.S. provisional patent applications titled “KEYSTROKE INPUT DEVICE FOR USE WITH AN RFID TAG AND USER VERIFICATION SYSTEM,” Ser. No. 60/582,252, filed Jun. 22, 2004; and “KEYSTROKE INPUT DEVICE FOR USE WITH AN RFID TAG AND USER VERIFICATION SYSTEM,” Ser. No. 60/583,582, filed Jun. 28, 2004. The identified earlier-filed provisional applications are hereby incorporated by reference into the present application.

### BACKGROUND OF THE INVENTION

1. Field of the Invention

The present invention relates to devices that automatically log a user into a secure computer or computer network. More particularly, the present invention relates to a device that reads an identification number from an identification device associated with a user, creates a login script associated with the identification number, and logs the user into a computer by communicating the login script to a keyboard input port of the computer.

2. Description of Prior Art

Computer systems, pharmacy automation systems, and other systems that contain sensitive information often employ security measures, such as requiring users to log into and out of the system. Operators of such systems, however, often spend only a portion of their time at the systems. Engineers, for example, may spend part of their time at their computer using design software and reading specifications, and part of their time in a laboratory or in the field building and/or testing a design. To ensure complete security, a user may need to log out of the system each time he or she leaves, requiring a new login upon returning. This can become time consuming, and may open the door to security breaches if the user forgets to log out.

Also, in many environments, such as in pharmaceutical prescription filling environments, restaurants, and other patient or customer service environments, multiple users share the same computer. In those environments, no specific user is logged into the system, and it becomes necessary to identify, authorize and record the user for every transaction that is entered. This often necessitates repeated input of user identification numbers or scanning of user badges. Use of identification numbers and badges is not only inconvenient, but also introduces the risk of an unauthorized user obtaining an identification number and/or badge and accessing the system, thus compromising security. Finally, systems that employ scannable user badges and similar technology require each computer in the system to have the necessary hardware, software and/or network connections necessary to identify each user. It will be appreciated that such systems are incompatible with standalone computers.

Due to the above-mentioned and other problems and disadvantages in the art, a need exists for an improved computer security device that automatically logs a user into and out of a secured system by detecting an identification tag worn by a user, wherein the device does not require the computer to include any pre-installed hardware or software components and may be used with a computer that is not connected to a computer network.

### SUMMARY OF THE INVENTION

The present invention provides an improved keystroke input device for use with an RF identification tag and user verification system that does not suffer from the problems and limitations of the prior art described above. Particularly, the present invention provides a secure automated login device that includes an antenna for interrogating an identification tag worn by a user and a network connection for retrieving a login script from a computer on a network. The login device communicates the login script, typically a username and password, to a keyboard input port of a host computer in a manner that mimics user input via a keyboard.

In one embodiment of the invention, the device comprises an antenna for receiving a wireless identification signal, a controller for receiving the identification signal from the antenna and for generating an output signal that includes login information corresponding to the identification signal, and an output port for communicating the output signal to a keyboard input port of an external computer.

In a second embodiment of the invention, the device further comprises a keyboard input port for receiving a keyboard input signal from an external keyboard and an activation interface for generating an activation signal when a user engages the activation interface. The controller receives the keyboard input signal, the activation signal, and the identification signal and generates the keyboard output signal upon receiving the input signal. The keyboard output signal includes login information that corresponds to the identification signal if the input signal is a predetermined login keystroke signal and is received simultaneously with the activation signal. If the input signal is not the predetermined login keystroke signal and received simultaneously with the activation signal, the keyboard output signal is identical to the keyboard input signal.

In a third embodiment of the invention, the device comprises the keyboard input port for receiving the keyboard input signal from the external keyboard; the antenna for communicating an RF interrogation signal to an electronic identification tag worn by a user and for receiving an RF identification signal from the tag wherein the antenna extends around the periphery of the external keyboard; an activation touch pad integral with the login device for sensing the presence of the user's finger by measuring a capacitance of a surface of the pad, and for generating the activation signal when the user's finger is present; a first network port for enabling communications between the login device and a computer network; and a second network port for enabling communications between an external electronic device and the computer network.

The controller receives the keyboard input signal, the activation signal, and the identification signal and interrogates the identification tag by communicating an interrogation signal to the antenna upon simultaneously receiving the activation signal and the predetermined login keystroke signal from the keyboard input port. The controller further receives the RF identification signal from the antenna and determines an identification number from the signal, requests a login script from an external identification server via the first network port upon receiving a valid identification number, receives the login script via the first network port, and generates a keyboard output signal that includes the login script. Finally, the controller illuminates a first LED when interrogating the identification tag, causes the first LED to blink when the device has received the valid identification number and is requesting a login script from the identification server, and activates a second LED if no login script is received within a predetermined period of time after requesting the login script.

The device further includes a keyboard output port for communicating the keyboard output signal to an external computer and an attachment component for securing the login device to a keyboard.

In another embodiment of the invention, the device comprises a control panel and a base portion. The control panel houses the antenna, the activation pad, and an attachment component for securing the control panel to a keyboard. The base portion includes a communication cable connecting the base portion and the control panel for enabling communications between components of the control panel and components of the base portion and the keyboard input port for receiving a keyboard input signal from the keyboard. The controller receives the keyboard input signal and the activation signal and interrogates the identification tag by communicating an interrogation signal to the antenna upon simultaneously receiving the activation signal from the activation pad and a predetermined keystroke login signal from the keyboard input port. The controller further receives the RF identification signal from the antenna and determines an identification number from the signal, solicits a login script from an external identification server upon receiving a valid identification number, receives the login script, and generates a keyboard output signal that includes the login script. A keyboard output port communicates the keyboard output signal to an external computer.

In another embodiment of the invention, the device is integral with a keyboard and includes the antenna, a keypad for generating keystroke signals and a controller for receiving the keystroke signals, for receiving the identification signal from the antenna, and for generating a keyboard output signal including login information that corresponds to the identification signal. The device further includes a memory element for storing the login information and communicating the information to the controller, and an output port for communicating the keyboard output signal to an external computer.

Another embodiment of the invention comprises an automated user verification system. The system includes a keyboard for generating keystroke signals, an identification tag worn by a user for storing and wirelessly communicating an identification number in response to an interrogation signal, a registration device for acquiring biometric information from the user, for acquiring the identification number from the electronic identification tag worn by the user, and an identification server for receiving the biometric information and the identification number from the registration device, for receiving a login script request including the identification number, and for generating a login script including a username and a password based on the identification number. The system further includes a secure automated login device for interrogating the identification tag upon receiving a predetermined login keystroke signal from the keyboard, for receiving the identification number from the identification tag, for communicating the identification number to the identification server and receiving the login script from the identification server, and for communicating the login script to a host computer.

Another embodiment of the invention includes a method of automatically logging a user into a computer system. The method comprises the steps of receiving a wireless identification signal, generating computer login information with a digital controller wherein the login information corresponds to the identification signal, and communicating the login information to a keyboard input port of a computer.

In another embodiment of the invention, the method comprises the steps of receiving a predetermined keyboard signal from a keyboard, receiving an activation signal from an activation interface when a user engages the activation interface, and interrogating an external identification device by wirelessly communicating an interrogation signal to the device if the keyboard signal and the activation signal are received simultaneously. The method further comprises the steps of illuminating a first LED upon communicating the interrogation signal, receiving the identification signal from the identification device, causing the first LED to blink upon receiving the identification signal; determining an identification number from the identification signal; encoding the identification number, communicating the encoded identification number to an identification server, illuminating a second LED if a login script is not received from the identification server, receiving an encoded login script from the identification server, decoding the login script, and communicating the decoded login script to the host computer.

These and other important features of the present invention are more fully described in the section titled DETAILED DESCRIPTION OF PREFERRED EMBODIMENTS, below.

### BRIEF DESCRIPTION OF THE DRAWINGS

A preferred embodiment of the present invention is described in detail below with reference to the attached drawing figures, wherein:

FIG. 1 is a perspective view of a login device constructed in accordance with a first preferred embodiment of the invention;

FIG. 2 is a perspective view of a login device constructed in accordance with a second preferred embodiment of the present invention;

FIG. 3 is a perspective view of the login device of FIG. 1 shown connected to a host computer and a keyboard;

FIG. 4 is a perspective view of the login device of FIG. 1 shown connected to a host computer, a keyboard and a remote computer;

FIG. 5 is a perspective view of the login device of FIG. 2 shown connected to a host computer and a keyboard;

FIG. 6 is a perspective view of a login device constructed in accordance with a third preferred embodiment of the present invention, wherein the device is embodied in a computer keyboard that is connected to a host computer and to a remote computer;

FIG. 7 is a block diagram of the components of the login device of FIG. 1 showing a controller connected directly to first and second network ports;

FIG. 8 is a block diagram of the components of the login device of FIG. 1 showing a controller connected to a network interface circuit; and

FIG. 9 is a flowchart of steps involved in using the login device of FIG. 1.

### DETAILED DESCRIPTION OF PREFERRED EMBODIMENTS

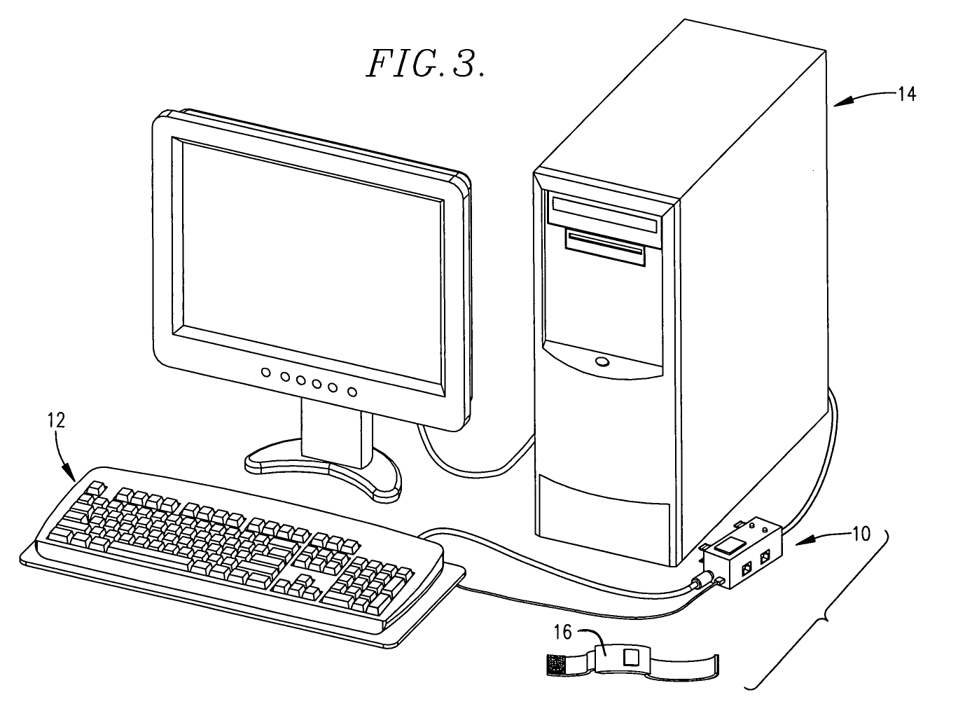

Referring initially to FIGS. 1 and 3, an exemplary secure automated login device employing the principles of the present invention is shown and designated generally by the reference numeral 10. The login device 10 is used with a standard computer keyboard 12 and a host computer 14 by connecting to a keyboard output port of the keyboard 12 and to a keyboard input port of the computer 14. The device 10 identifies a user via a wireless identification tag 16 worn by the user; and logs the user into the computer 14 by communicating login information to the keyboard input port of the computer 14. The login device 10 comprises a keyboard input port 18; an activation interface 20; an antenna 22; a controller 24; a memory element 26; a plurality of network ports 28, 30; a keyboard output port 32; a plurality of status indicators 34, 36; and a housing 38 including an attachment component 40.

The keyboard input port 18 generally provides a path for communicating data and/or electrical power between the login device 10 and an external electronic device. More particularly, the illustrated keyboard input port 18 mates with an electrical connector 42 of the keyboard 12, wherein a data and/or power signal is communicated from the keyboard 12 via the electrical connector 42 to the keyboard input port 18 of the login device 10. The electrical connector 42 and the keyboard input port 18 are preferably standard male and female connectors, respectively, of a type commonly used to connect computer keyboards to computers such as, for example, a 5-pin DIN (Deustche Industrie Norm) connector; a 6-pin IBM™ PS/2 mini-DIN connector; or a Universal Serial Bus (USB) connector.

As mentioned previously, data and/or power signals may be communicated between the device 10 and the keyboard 12. Computer keyboards commonly receive electrical power from a host computer or other device to which they are attached. The login device 10 preferably communicates electrical power to the keyboard 12 via the input port 18 in a similar manner to render the login device 10 compatible with keyboards designed to receive electrical power from a host device. It will be appreciated, though, that the present invention further contemplates communication of data only via the input port 18 (e.g., a wireless keyboard) and/or a transfer of electrical power from the keyboard 12 to the login device 10 (e.g., a keyboard that draws electrical power from another source). Thus, while the login device 10 preferably receives electrical power from the host computer 14, the device 10 may alternatively and/or supplementally receive electrical power from the keyboard 12.

Alternatively, the input port 18 may include a wireless transceiver (not shown) to provide for wireless communication of data between the device 10 and a similar transceiver coupled to an external device, such as the keyboard 12. Such a wireless transceiver may use one or more of a variety of different wireless technologies common to short-range wireless data communications to communicate with the external device including, for example, the Bluetooth, 27 MHz, and/or WiFi technologies. Bluetooth and WiFi devices are designed to transmit short bursts or packets of data over short ranges using unlicensed high-frequency channels such as the 2.4 GHz frequency band. Such communication technologies typically establish a frequency-hopping radio link using many different frequencies at approximately 1 MHz intervals to give a high degree of immunity from interference with other transmissions.

The 27 MHz technology uses the 27 MHz ISM (Industrial, Scientific, Medical) radio frequency band. There are four channels available in this frequency band: two can be used for a wireless keyboard and two can be used for a wireless mouse. Because the 27 MHz frequency is not commonly used by other types of wireless devices (such as cordless phones or wireless network devices), there is little risk of interference from such devices. Also, the availability of two channels per keyboard and mouse reduces the risk of interference with other wireless keyboard or mouse devices that may be nearby.

It will be appreciated that the input port 18 is not restricted to the embodiments described and illustrated herein, and may take a variety of forms and implement one or more of various technologies in accordance with the spirit of the present invention. The input port 18 may include, for example, wireless USB or other emerging short-range wireless technologies.

The activation interface 20 generally allows the user to control when login information is communicated to the computer 14 by generating an activation signal when the user engages the activation interface 20, wherein the activation signal directs the controller 24 to obtain and/or communicate the login information to the computer 14, as described below in greater detail. The illustrated activation interface 20 includes a touch pad that senses a presence of a user's finger on a surface of the pad and generates the activation signal when the user's finger is present. The activation interface 20 may employ any of various technologies commonly understood by those skilled in the art to sense the presence of the user's finger. The activation interface 20 may, for example, measure a capacitance and/or a resistance of the pad surface, or may employ a surface acoustic wave system. It will be appreciated that the activation interface 20 need not employ a touch-sensitive pad as described herein but may include any type of button, switch or sensor that responds to user engagement by communicating an activation signal to the controller 24 such as, for example, a common tactile switch.

It will be appreciated that use of the activation interface 20 preserves the functionality of the keyboard and prevents inadvertent and/or undesired login requests. The activation interface 20 preserves the functionality of the keyboard 12 by eliminating the need for a key or combination of keys on the keyboard 12 to be dedicated solely to initiating a user login. The activation interface 20 prevents inadvertent and/or undesired login requests because the activation interface 20 is separated from the keyboard 12 by a distance and therefore requires the user to make a specific effort, distinct from usual typing motions, to engage the activation interface 20. The risk of inadvertent login is further reduced if the user is required to simultaneously engage both the activation interface 20 of the login device 10 and a predetermined key of the keyboard 12 to initiate a login. In this latter situation, it will be appreciated, the functionality of the keyboard 12 is still preserved because the predetermined keyboard key retains its original functionality when not engaged simultaneously with the activation interface 20.

The antenna 22 generally captures electromagnetic signals communicated wirelessly from an external device and communicates the signals to the controller 24; and wirelessly broadcasts signals communicated from the controller 24 to the antenna 22. The illustrated antenna 22 broadcasts an RF interrogation signal to an electronic identification tag 16 (described below in greater detail) worn by the user and receives an RF identification signal from the tag 16. The antenna 22 includes a wire that passes through the housing 38 of the login device 10 and partially or completely extends around a periphery of the keyboard 12. The antenna 22 is preferably placed beneath or is integral with a keyboard pad 48 on which the keyboard 12 rests. Placing the antenna 22 around the periphery of the keyboard 12 removes the antenna 22 from sight and prevents it from becoming entangled with the user's hand or with computer equipment. More importantly, placing the antenna 22 around the periphery of the keyboard 12 allows for optimal communication with the wireless identification tag worn on a user's hand or wrist while the user is typing or otherwise working in the vicinity of the computer 14. The antenna 22 is preferably detachable from the login device 10 to facilitate setup of the system and replacement of the antenna 22, but may alternatively be integrally attached to the login device 10.

While the antenna 22 has been described as being in communication with the controller 24 and the external identification tag 16, use of the antenna 22 is not so restricted and may be used in other wireless communications as well. The antenna 22 may be used, for example, to enable wireless communications between the controller 24 and the keyboard 12; between the controller 24 and the host computer 14; and/or between the controller 24 and a remote computer via network communications. It will be appreciated that using the antenna 22 to wirelessly communicate with more than one device eliminates the need to include multiple antennas and therefore may make the login device 10 less expensive to manufacture and sell.

It will further be appreciated that the form and function of the antenna 22 is not restricted to the embodiment described and illustrated herein, and may take a variety of forms in accordance with the spirit of the present invention. For example, the antenna 22 may be embedded in the housing 38 of the login device 10, or may be an adjustable “whip” type antenna and/or a telescoping antenna commonly found on portable electronic devices. Furthermore, the antenna 22 may be a patch antenna completely internal to the login device 10 and/or internal to the controller 24.

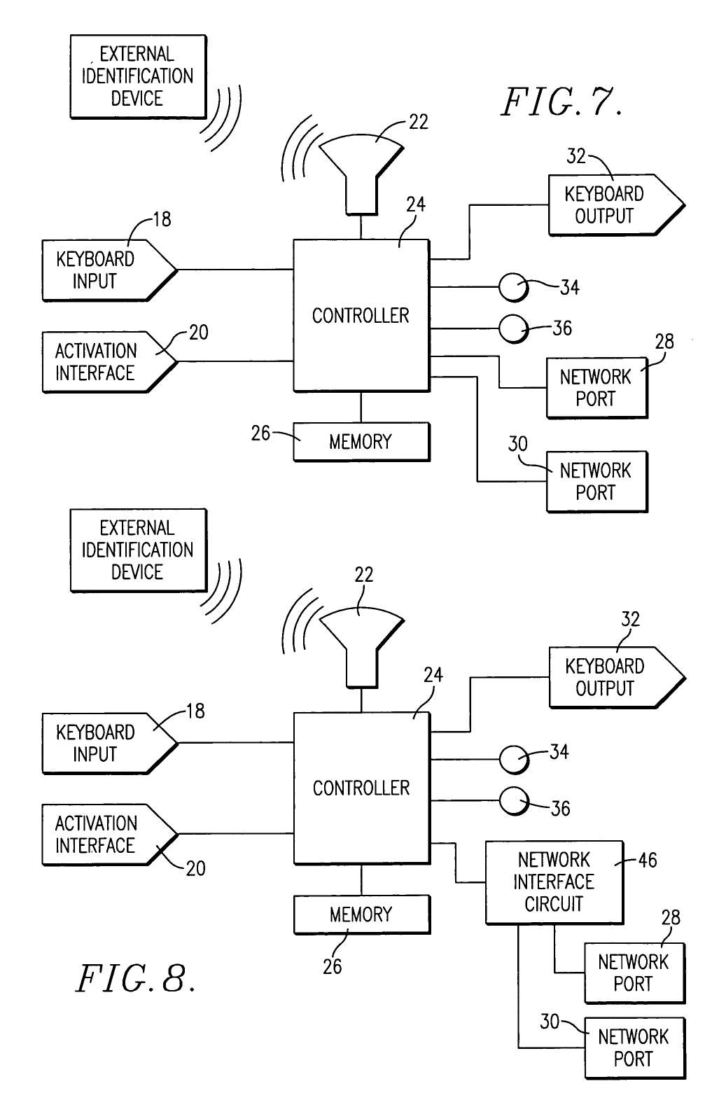

The controller 24 generally controls the other components of the login device 10 by responding, in a predetermined manner, to signals received from the other components. FIG. 7 presents a block diagram illustrating interaction between the controller 24 and the various other components of the login device 10. The illustrated controller 24 includes a digital processor commonly known in the art and may be custom designed for use with the present invention or may be a commercially available model intended for general use. The controller 24 includes inputs and outputs adapted to receive and send signals from the various other components of the login device 10, including the keyboard input port 18, the activation interface 20, the antenna 22, the memory element 26, the network ports 28, 30, the keyboard output port 32, and the status indicators 34, 36.

One of ordinary skill in the art will readily recognize that signals generated by other components, such as the activation interface 20 and the antenna 22, may not be compatible with the digital processor of the controller 24, and that signals generated by the digital processor of the controller 24 may not be compatible with such other components. Therefore, the controller 24 may include onboard circuits peripheral to the digital processor to translate the input signals into a form readable by the digital processor and the output signals into a form compatible with the other components. The controller 24 may include, for example, a digital to analog converter, an analog to digital converter, and/or a communications circuit. Alternatively, such peripheral circuits may be external to the controller 24 and/or integral with the other components of the device 10.

The memory element 26 generally stores data and communicates the data to the controller 24 in response to a request from the controller 24. The memory element 26 may store data received from an external source, such as a remote computer or peripheral computer device, and/or from the controller 24. The illustrated memory element 26 includes a random-access memory (RAM) element adapted to assist the controller 24 in a customary manner by, for example, receiving digital data from the controller 24 and communicating the data to the controller 24 when the controller 24 requests the data. The RAM element may be static or dynamic, synchronous or asynchronous. The memory element 26 may further include a read-only memory (ROM) element, a programmable read-only memory (PROM) element, an erasable programmable read-only memory (EPROM) element, and/or an electrically erasable programmable read-only memory (EEPROM) element. These various types of read-only memory are non-volatile, meaning they retain data even while electrical power is not supplied to the memory. Such read-only memory would be particularly useful, for example, if the login device 10 is not connected to a computer network and all of the login information is stored in the memory element 26, as explained below.

The illustrated memory element 26 is permanently attached to the login device 10 and housed within the housing 38. It will be appreciated, though, that the memory element 26 may be removably attached to the login device 10. Removable memory elements are becoming increasingly popular in portable electronic devices such as digital cameras, video game devices, and laptop or notebook computers. Such removable memory elements are typically solid-state devices that are adapted to mate with an externally-accessible memory slot of a device so that a user may connect the memory element to the device and remove the memory from the device with minimal effort. One of the most common forms of removable memory elements is flash memory, which is a type of EEPROM. Flash memory has been implemented in various types of electronic devices, including basic input/output system (BIOS) chips in personal computers; data storage in digital cameras, including the CompactFlash™ and SmartMedia™ brands; PCMCIA Type I and Type II memory cards and USB flash drives (used as solid-state disks in laptop and notebook computers); and memory cards for video game consoles.

Use of a removable memory element would be particularly useful where the login device 10 is not connected to a computer network for security or other reasons. In such a situation, the login device 10 would not be able to communicate directly with a remote computer to obtain identification information. A removable memory element would facilitate communication of information between the login device 10 and the remote computer by allowing a user to connect the memory element to the remote computer, transfer identification information from the remote computer to the memory element, physically carry the memory element to the login device 10, and connect the memory element to the login device 10 so that the login device 10 could read the identification information stored on the memory element.

One skilled in the art will appreciate that the memory element 26 is not restricted to the embodiments described and illustrated herein, and may take a variety of forms in accordance with the spirit of the present invention. For example, the memory element 26 may comprise several types of memory elements, such as elements that are permanently attached to the login device 10 and elements that are removable therefrom. Furthermore, the memory element 26 may use various types of technology and media to store and communicate data, such as, for example, floppy disks and hard disks.

The keyboard output port 32 generally provides a path to communicate data and/or electrical power between the login device 10 and an external electronic device. More particularly, the illustrated keyboard output port 32 includes a cable with an electrical connector 44 (not shown) adapted to mate with a keyboard input port (not shown) of the host computer 14, wherein a data and/or power signal is communicated between the login device 10 and the computer 14. The electrical connector 44 of the login device 10 may be substantially identical to the electrical connector 42 of the keyboard, and the keyboard input port of the computer 14 may be substantially identical to the keyboard input port 18 of the login device 10. Therefore, the discussion set forth above describing the keyboard electrical connector 42, the keyboard input port 18 of the login device 10, and the relationship between the two will serve to describe the electrical connector 44 of the login device 10 and the keyboard input port of the computer 14.

The login device 10 preferably receives electrical power from the host computer 14 via the keyboard output port 32 of the login device 10, and the login device 10 preferably communicates power to the keyboard 12 via the keyboard input port 18, thus rendering the login device 10 compatible with standard computers and keyboards. Alternatively, the login device may receive all or part of its electrical power from another source, such as from an external power converter connected to a power receptacle (not shown) of the login device 10.

From the foregoing discussion it will be apparent to those skilled in the art that the login device 10 serves an intermediary role between the keyboard 12 and the computer 14 by receiving data from the keyboard 12 and communicating the data to the computer 14. Neither the keyboard 12 nor the computer 14 would need special adaptation to function with the login device 10; that is, from the standpoint of the keyboard 12 it “looks like” the keyboard 12 is communicating directly with the computer 14 in the usual manner, and from the standpoint of the computer 14 it “looks like” the computer 14 is communicating directly with the keyboard 12 in the usual manner. This feature of the present invention enables it to be used with pre-existing systems that do not include special hardware or software necessary for secure automatic logins.

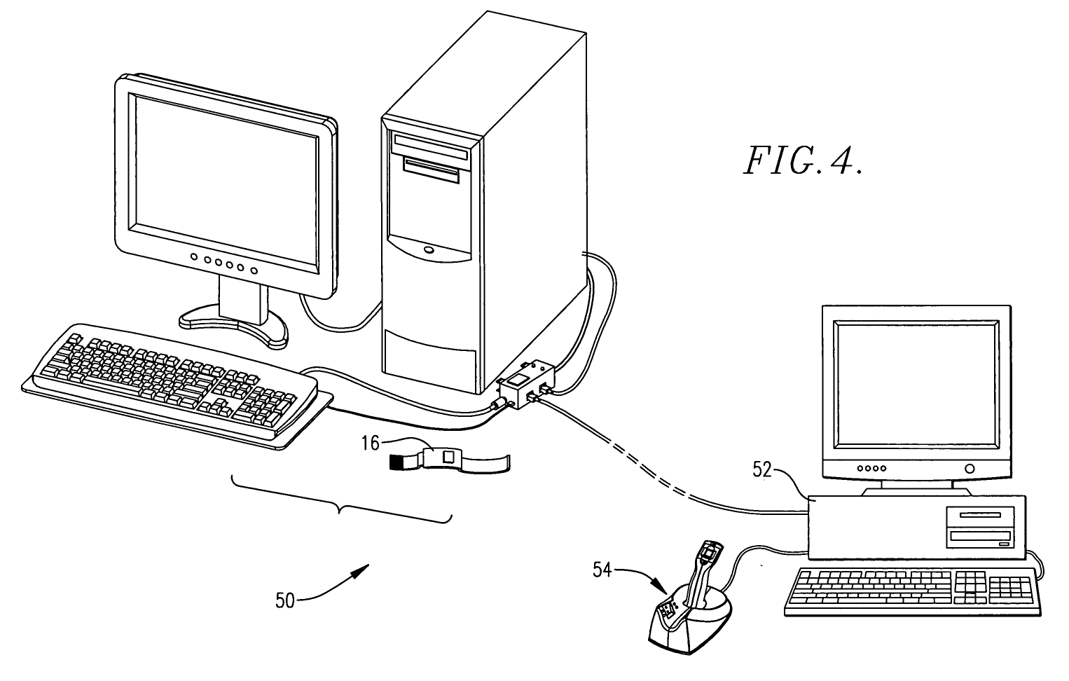

The network ports 28, 30 generally provide a path for communicating data between the login device 10 and one or more remote computers, such as, for example, the computer 52 illustrated in FIG. 4. The illustrated network ports 28, 30 connect the controller 24 to a computer network to enable the controller 24 to communicate data to the remote computers and to receive data from the remote computers. The network ports 28, 30 may implement one or more of various networking technologies, such as local area network (LAN), wide area network (WAN), wired and wireless networking technologies; and may be compatible with one or more networking standards and protocols, such as Ethernet, Token Ring, Asynchronous Transfer Mode and TCP/IP. It will be understood that the term “remote computer” does not strictly refer to a computer stored at a location geographically remote from the login device 10, but refers to any computer that communicates with the login device 10 via the network ports 28, 30 and may include, for example, a computer in the same room or building as the login device 10.

The controller 24 may control and direct network communications over the network ports 28, 30, or a network interface circuit 46 may be included in the login device 10 to control and direct the network communications over the network ports 28, 30 as illustrated in FIG. 8. The network interface circuit 46 may be used, for example, to relieve the controller 24 of the burden of controlling and directing network communications, allowing the controller 24 to dedicate processing time and resources to controlling the other functions of the login device 10. This would be particularly advantageous where, for example, users frequently log into and out of the computer 14 so that the processing resources of the controller 24 are occupied with login and logout operations. The network interface circuit 46 may include a digital processor or may include a more simple digital circuit. It will be appreciated that the login device 10 may include a plurality of network ports of one or more different types, further increasing the usefulness of the login device 10 by rendering it compatible with various network technologies.

A private-key encryption scheme is preferably used to encode and decode communications between the controller 24 and other computers on the network, such as the identification server. In a private-key encryption scheme the controller 24 and the identification server each has a private (secret) key (or “code”) that enables it encode and decode the communications. Alternatively, a public-key encryption scheme could be used, wherein a combination of public and private keys are used. While public-key encryption is generally less secure than private-key encryption, it may prove useful where, for example, the system includes a lager number of login devices 10 communicating with an identification server over the Internet so that private keys cannot be distributed in a secure and timely manner.

The status indicators 34, 36 generally inform the user of a status of operation of the login device 10. The illustrated status indicators 34, 36 are light-emitting diodes (LEDs) located on the housing 38 of the login device 10 to be readily visible to the user. LEDs are preferable for use as indicators because they consume less energy, are more durable, and have a longer useful life than other types of light sources, particularly incandescent bulbs. The status indicators 34, 36 may be complemented by interface circuitry adapted to allow the controller 24 to control the indicators 34, 36 such as, for example, resistors. Such circuitry may be integral with the controller 24, integral with the status indicators 34, 36, or may be independent of either. It will be appreciated that the external indicators may be embodied in a variety of forms and employ any of various technologies to inform the user of a status of operation of the login device 10. The status indicators 34, 36 may include, for example, one or more speakers, piezoelectric buzzers, or other transducers operable to generate an audible status alert.

The housing 38 generally protects the other components of the login device 10 and provides a surface on which the activation interface 20 and the status indicators 34, 36 are mounted. More particularly, the illustrated housing 38 encloses and contains the other components of the device so as to protect and shield them from the hazards of use (e.g., jostling, dropping, other mechanical shock) and of the environment (e.g., food, drink, dust). As such, the housing is preferably constructed from a suitable impact-resistant material such as, for example, plastic, nylon, aluminum, or any combination thereof. Additionally, the housing preferably includes one or more appropriate gaskets or seals to make it substantially waterproof or resistant. Though shown as being substantially rectangular, the housing may take any suitable shape, including, for example, molded to substantially correspond to a portion of the keyboard 12, the computer 14, or other object to which it may be attached; or molded to present other useful and/or aesthetic characteristics. Furthermore, the housing 38 may include a grill or other design feature allowing air flow through the housing 38 to cool the controller 24 and/or other components of the device 10.

The attachment component 40 is secured to the housing 38 and generally attaches the login device 10 to the keyboard 12, to the host computer 14, or to another object. The illustrated attachment component 40 includes a pair of clips for conveniently clipping the login device 10 to the keyboard 12. Alternatively, the attachment component 40 may include a hook-and-loop fastener, such as the VELCRO™ brand hook-and-loop fastener, or may include an adhesive or magnetic material.

The login device 10 is preferably used as part of a secure login system, such as the system 50 illustrated in FIG. 4. The system 50 is described in detail in copending patent application Ser. No. 10/869,595, (the '595 application) filed on Jun. 16, 2004 and entitled “RFID TAG AND METHOD OF USER VERIFICATION,” herein incorporated by reference into the present application. The system described in the '595 application broadly comprises a computer 52, a verifier 54, an RF identification tag reader (not shown), and the RF identification tag 16 worn by the user. The system 50 associates the tag 16 with a user wearing the tag by first acquiring the user's biometric information, such as fingerprint information, via the verifier 54. The computer 52 determines an identity of the user by matching the user biometric information with biometric information and related identity information (such as a name and an employee number) stored in an identity database. The computer 52 then associates the tag 16 with the user by acquiring an identification number from the tag 16 and associating the identification number with the user's identity information by storing both in a database of active users (an “active user database”). Thereafter when the user approaches the computer 52, the RF identification tag reader acquires the identification number from the tag 16, determines the identity of the user by retrieving identity information from the active user database that corresponds to the identification number, and automatically grants or denies computer access based on the user's identity.

The login device 10 complements the system of the '595 application by providing to users wearing identification tags secure and automated access to computers that are not equipped to read the RF identification tag and/or are not adapted to access one or more of the system databases. To combine the login device 10 with the system of the '595 application, a database correlating user login information with user identity information (the “login information database”) is created and stored on the computer 52 along with the active user database (correlating identification numbers and user identity information) and the user identity database (correlating user biometric information and identity information). When connected to the computer network, the computer 52 can then function as an identification server. When the login device 10 communicates an identification number to the computer 52 via the network, for example, the computer 52 can verify that the identification number validly corresponds to a user by querying the active user database and can further retrieve a login script by querying the user login database.

It will be appreciated that when the login device 10 and the system of the '595 are combined, the various databases discussed above—including the active user database, the login information database, and the identity database—may reside on a single computer or on separate computers. The databases may be stored, for example, on a hard disk of the computer 52, or on another server computer dedicated to storing and managing such data. Alternatively, each database may be stored separately on geographically remote computers connected via a computer network such as the Internet. It will also be appreciated that because the login device 10 communicates with the databases via one of the network ports 28, 30, the entire system may include many login devices 10 located throughout a building or over a broad geographic range. While the '595 application teaches an exemplary system in which the login device 10 may be used, it will be appreciated that the login device 10 may be used with any of a variety of different systems in a variety of settings, or may be used independently of such systems.

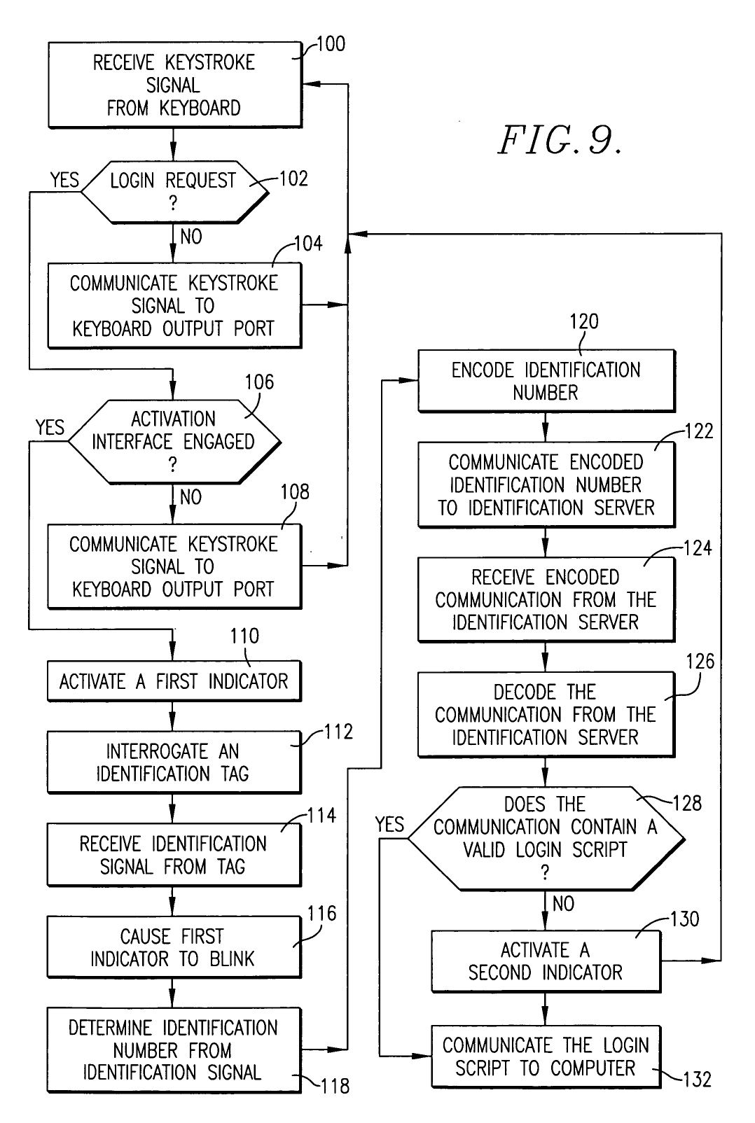

FIG. 9 presents a flowchart of steps involved in using the login device 10. In use, a user registers the RF identification tag with the system 50 by, for example, using the registration device 54 to submit fingerprint information and the identification number of the tag 16 to the computer 52, which associates the user with the tag 16 as explained above. When the user approaches the computer 14 wearing the RF identification tag 16, the computer 14 prompts the user to submit login information before granting the user further access. The user communicates a login request signal to the computer 14 by pressing a predetermined keyboard key, such as a function key, to begin the login process. The keyboard 12 communicates the keystroke login signal to the keyboard input port 18 of the login device 10 via the keyboard electrical connector 42 attached to the input port 18. The controller 24 receives the login request signal from the input port 18, as depicted in block 100. The controller 24 determines whether the signal is a login request signal, as depicted in block 102 by, for example, comparing the signal to a login signal stored in memory element 26. If the keystroke signal is not a login request signal, the controller 24 communicates the signal to the keyboard output port 32, as depicted in block 104.

If the controller 24 determines that the keystroke signal is a login request signal, the controller 24 further determines whether the user is engaging the activation interface 20, as depicted in block 106, by, for example, measuring the voltage on an input pin connected to the activation interface 20. If the controller 24 detects an activation signal simultaneously with a login signal, it activates the first status indicator 34 and interrogates the RF identification tag 16 worn by the user to ascertain an identification number, as depicted in blocks 110 and 112. If the controller 24 does not detect an activation signal it does not interrogate the RF identification tag 16 but communicates the keystroke signal to the keyboard output port 32, as depicted in block 108.

The login request signal may correspond to any keyboard key, such as a function key, a letter key, or a number key. Furthermore, the login request signal may also correspond to a combination of keys, such as a combination of the control key with a function key. It will be appreciated that using a combination of keyboard keys to generate the login request signal increases the security of the system by requiring users to know the key combination, thus making it more difficult for an illicit user to generate a login request signal.

The controller 24 interrogates the RF identification tag 16 by communicating an interrogation signal to the antenna 22, wherein the antenna 22 wirelessly transmits the interrogation signal to the identification device. After communicating the interrogation signal to the antenna 22, the controller 24 activates status indicator 34 to inform the user that the controller 24 is interrogating the identification device, as depicted in block 110. The controller 24 may activate the indicator 34 for a predetermined period of time, such as for three or four seconds, or until a predetermined even occurs, such as when an identification signal is received by the controller 24. The controller 24 activates the indicator 34 by, for example, changing a voltage level on an output pin connected to the indicator 34.

The identification tag 16 receives the interrogation signal and responds by transmitting an identification signal that includes an identification number. The login device 10 receives the identification signal, as depicted in block 114, when the antenna 22 captures the identification signal and communicates the signal to the controller 24. The controller 24 determines the identification number from the signal, as depicted in block 118. The controller 24 intermittently activates and deactivates the indicator 34 (i.e., causes it to “blink”) to inform the user that the controller 24 has received an identification number, as depicted in block 116. The controller 24 then encodes the identification number, as depicted in block 120, and requests a login script corresponding to the identification number by communicating the encoded identification number to a remote identification server, such as the computer 52, via the network port 28, as depicted in block 122. The identification server retrieves the login script corresponding to the identification number from a database, as explained above, and encodes and communicates the login script to the login device 10 via the network port 28. The login device 10 receives and decodes the encoded login script, as depicted in blocks 124 and 126. If the identification number is invalid, the identification server encodes and communicates an error message to the login device 10 indicating such.

The controller 24 receives and decodes the communication from the network port 28, as depicted in blocks 118 and 120, and determines whether it is a login script or an error message. If the communication from the identification server is an error message, the controller 24 illuminates the external indicator 36 to inform the user that login information was not received. If the communication from the identification server is a login script, the controller 24 communicates the script to the computer 14 via the output port 32, as depicted in block 122. The computer 14 receives the login script just as it would receive a username and password directly from a keyboard if a user had typed the login information on the keyboard.

While the login device 10 has generally been described as acquiring information from an external source to generate the login script, it may alternatively generate the login script internally by, for example, storing the login script in memory element 26 or employing an algorithm to generate the login script. Internally generating the login script makes the login device 10 more flexible in that the device 10 does not have to be connected to a network or otherwise access an identification server. Furthermore, internally generating the login script renders the system more secure by, for example, eliminating the risk of a third party intercepting a network communication including sensitive user information.

It will be appreciated that one or more of the steps explained above and illustrated in FIG. 9 may be performed in a different order than that shown, may be performed concurrently with one or more of the other steps, or may be entirely omitted. The step of determining whether the user is engaging an activation interface may be omitted, for example, so that a user initiates the login process by merely pressing a predetermined key on the keyboard.

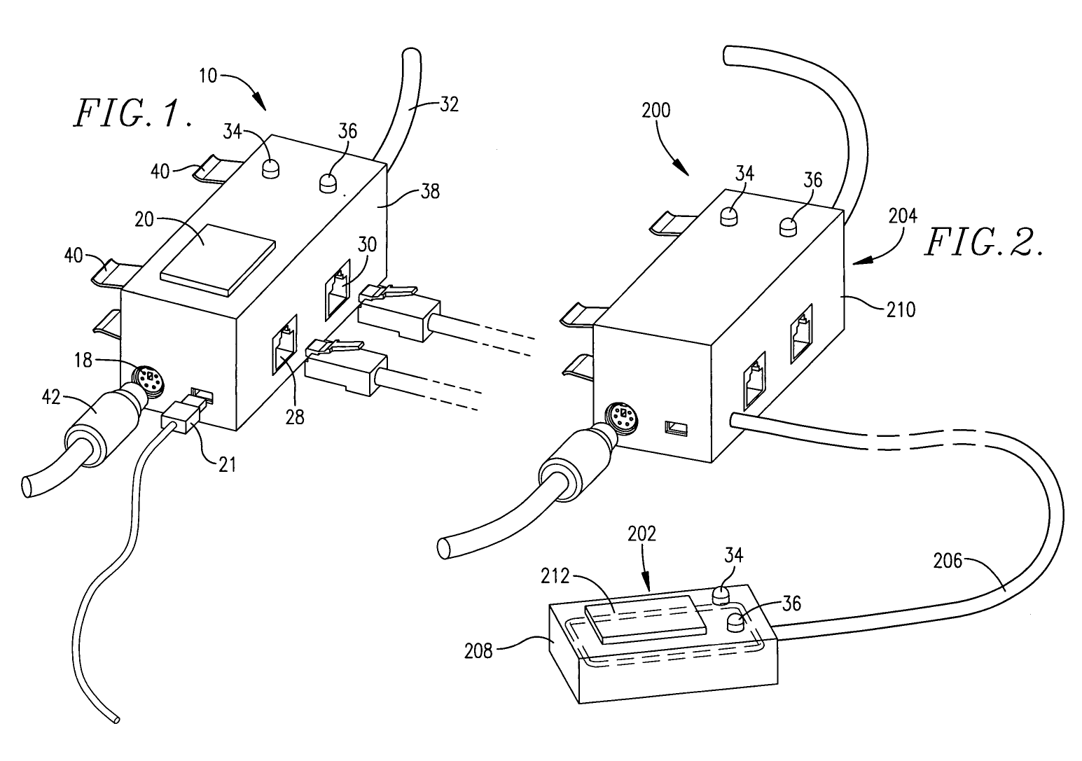

Referring now to FIG. 2, a second embodiment of the secure automated login device employing the principles of the present invention is shown and designated generally by the reference numeral 200. The login device 200 generally comprises a control panel 202 and a base portion 204 electrically connected via a cable 206. The various components of the login device 10 are included in the login device 200 and are contained on or within a control panel housing 208 and a base portion housing 210. Status indicators 34, 36 are complemented by a third status indicator 214 and a fourth status indicator 216 located on the control panel 202. An activation interface 212 is also located on the control panel 202.

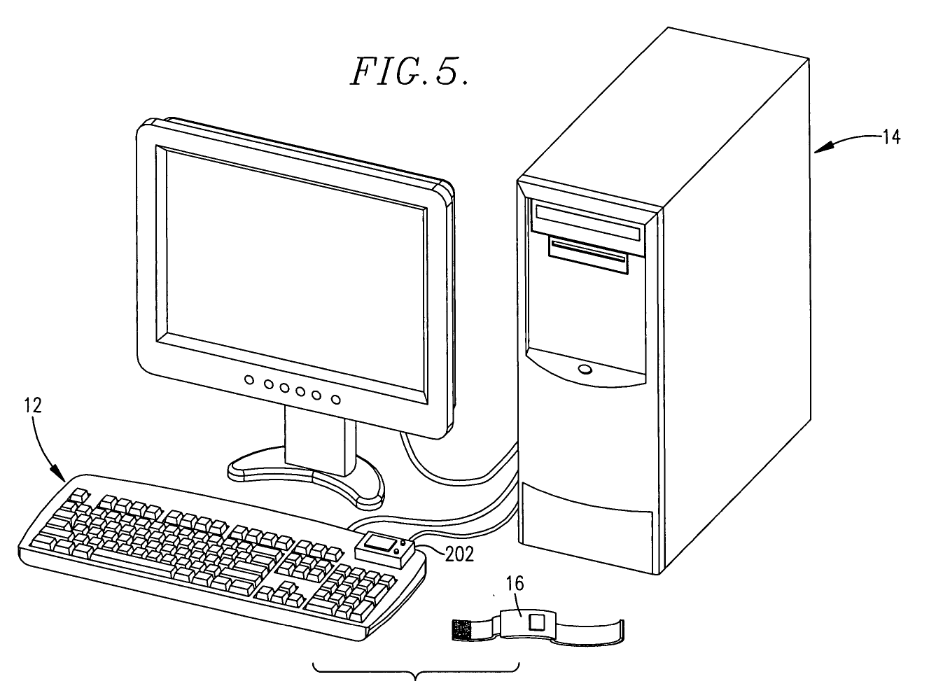

Referring also to FIG. 5, the login device 200 is used with the keyboard 12 and the host computer 14 and functions in a manner substantially identical to the login device 10, the main difference being that the base portion 204 and the components contained therein may be located at some distance from the keyboard 12 (hidden behind the computer 14 in FIG. 5) while the control panel 202 may be attached to the keyboard 12 (as illustrated), to the computer 14, or otherwise located near the keyboard 12. It will be appreciated that separating the control panel 202 and the base portion 204 facilitates use of the login device 200 by, for example, reducing the space needed to mount the control panel 202. The control panel 202 can easily be mounted in various places on the keyboard 12, for example, including on a face of the keyboard 12. Physically separating the control panel 202 from the base portion 204 also renders the work area of the computer 14 more aesthetically pleasing because the base portion 204 can be hidden from view so that fewer total devices and cables are visible in the area.

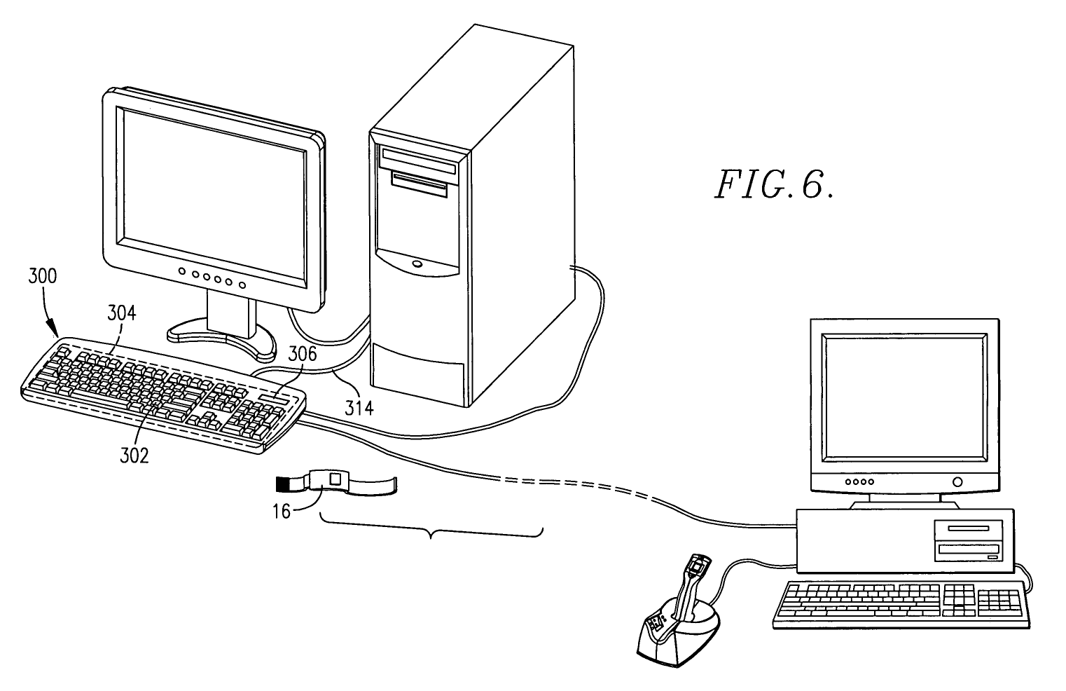

Referring now to FIG. 6, a third embodiment of the secure automated login device employing the principles of the present invention is shown and designated generally by the reference numeral 300. The login device 300 generally presents the features of the login device 10, described above, integrated into a standard keyboard. The keyboard 300 comprises a keypad 302; an antenna 304; an activation interface 306; a controller 308; a plurality of network ports 310, 312; and an output port 314.

A standard keyboard is essentially a series or matrix of switches connected to a microprocessor, wherein the microprocessor monitors the state of each switch and initiates a specific response to a change in that state. If a user depresses the key labeled “a”, for example, a switch is activated (or deactivated). The microprocessor detects the change in state of the switch and communicates a data signal corresponding to the letter “a” to a host computer. Thus, as the user types on the keyboard, the processor in the keyboard is analyzing the key matrix and determining what characters to send to the computer. It maintains these characters in a buffer of memory that is usually about sixteen bytes large. It then sends the data in a stream to the computer via some type of connection. The most common keyboards are the 101-key enhanced keyboard, the 104-key WINDOWS™ keyboard, the 82-keyAPPLE™ standard keyboard, and the 108-key APPLE™ Extended keyboard.

The keyboard 300 employs the same basic technology as standard keyboards, complemented by the principles of the present invention. The controller 308, for example, is preferably substantially identical to the controller 24 in form and function, but further monitors and responds to changes in the key switch matrix-thus eliminating the need for two processors or controllers in the keyboard 300. The functionality of the controller 308 is described below in greater detail.

The keypad generally presents a series of keys that allow a user to submit information to the computer. The illustrated keypad 302 functions in a similar manner as standard keypads by including, for example, a switch matrix that is monitored by the controller 308. The keypad 302 includes an activation interface 306 and status indicators 316, 318 that are substantially identical to the activation interface 20 and the indicators 34, 36 described above in relation to the login device 10. The activation interface 306 is preferably in addition to the standard keys of the keypad 302 to facilitate use of the system by, for example, reducing the amount of time required to learn how to use the keyboard 300. It will be appreciated that the keypad and the activation key need not take the precise form described and illustrated herein, but may take different forms. The keypad, for example, may be custom designed as opposed to presenting a standard matrix of keys; and the activation key may be a standard keypad key instead of a separate key.

The antenna 304 is substantially identical in form and function to the antenna 22 described above in relation to the login device 10. The antenna 304 is preferably integral with the keyboard 300, though, and thus remains completely hidden from the user's view. The network ports 310, 312 are located on a side (as illustrated) or a top of the keyboard 300 to allow a user to quickly and easily connect and disconnect network cables. Alternatively, the network ports 310, 312 may be wireless network ports, wherein they would include transceivers with separate antennas or may use the antenna 304 for wireless communications, as explained above in relation to the login device 10. The output port 314 is a standard keyboard output port that connects to a keyboard input port of a host computer 320 and may take a variety of forms as described in greater detail above in relation to the connectors of the login device 10 and the keyboard 12.

The controller 308 performs substantially all of the functions of the controller 24, described above, and further performs functions common to microprocessors embedded in standard computer keyboards. The controller 308 monitors the state of the switches in the key switch matrix and responds to changes thereto by, for example, communicating keystroke data to the output port 314. It will be appreciated that the keyboard 300 may include two controllers (not shown), wherein a first controller performs the functions of the controller 24 while the second controller performs the functions common to microprocessors embedded in standard computer keyboards. Furthermore, the keyboard 300 may include a third controller (not shown), wherein the third controller directs and controls communications over the network ports 310, 312.

In use, the keyboard 300 functions in essentially the same manner as the combination of the login device 10 and the keyboard 12 explained in detail above. The most notable differences are in setting up the keyboard 300. A user simply connects the keyboard 300 directly to the keyboard input port of the host computer 320, for example, instead of into the login device 10; and the user need not arrange or otherwise set up the antenna 304 as the antenna 304 is embedded in the keyboard 300. To log into the host computer 320 the user simply follows the steps for logging into the computer 14 via the login device 10, as explained above, but uses the activation interface 306 and status indicators 316, 318 that are integral with the keyboard 300.

Although the invention has been described with reference to the preferred embodiments illustrated in the attached drawings, it is noted that equivalents may be employed and substitutions made herein without departing from the scope of the invention as recited in the claims. It will be appreciated, for example, that the login device may be internal and/or integral with a computer, and may be integral with a computer monitor or other display.

Having thus described the preferred embodiment of the invention, what is claimed as new and desired to be protected by Letters Patent includes the following:

1. A secure automated login device comprising:
an antenna for receiving a wireless identification signal;
a controller for receiving the identification signal from the antenna and for generating an output signal that includes login information corresponding to the identification signal; and
an output port for communicating the output signal to a keyboard input port of an external computer.

2. The login device as set forth in claim 1, wherein the output port is a wireless keyboard port for wirelessly communicating the output signal to the external computer.

3. The login device as set forth in claim 1, wherein the login information includes a username and a password.

4. The login device as set forth in claim 1, further comprising an attachment component for securing the login device to a keyboard.

5. The login device as set forth in claim 1, further comprising a memory element for storing the login information and communicating the information to the controller.

6. The login device as set forth in claim 5, wherein the memory element includes a removable data storage device.

7. The login device as set forth in claim 6, wherein the removable data storage device includes a flash ROM.

8. The login device as set forth in claim 1, further comprising a keyboard input port for receiving a keyboard input signal from an external keyboard and communicating the input signal to the controller.

9. The login device as set forth in claim 8, wherein the keyboard input port is a wireless port for receiving wireless input signals from the external keyboard.

10. The login device as set forth in claim 8, wherein the controller interrogates an external identification device by communicating an interrogation signal to the antenna upon receiving a predetermined keystroke login signal from the keyboard input port, and receives the identification signal communicated from the identification device to the antenna.

11. The login device as set forth in claim 10, further comprising a first status indicator, wherein the controller activates the status indicator when interrogating the identification device.

12. The login device as set forth in claim 11, wherein the first status indicator is a light-emitting diode.

13. The login device as set forth in claim 10, wherein the controller determines a user identification number from the identification signal, requests a login script from an external identification server by communicating the identification number to the identification server, and receives a login script from the server corresponding to the identification number.

14. The login device as set forth in claim 13, wherein the controller communicates with the identification server according to the TCP/IP protocol.

15. The login device as set forth in claim 13, wherein the controller wirelessly communicates with the identification server via the antenna.

16. The login device as set forth in claim 13, wherein the controller encodes the identification number before communicating the number to the identification server, and decodes the login script from an encoded communication received from the identification server.

17. The login device as set forth in claim 13, wherein the controller causes the first status indicator to blink when the controller has received a valid identification number and is requesting a login script from the identification server.

18. The login device as set forth in claim 17, further comprising a second status indicator, wherein the controller activates the second status indicator if no login script is received within a predetermined period of time after requesting a login script from the identification server.

19. The login device as set forth in claim 18, wherein the second status indicator is a light-emitting diode.

20. The login device as set forth in claim 1, further comprising:
an activation interface for generating an activation signal when the user engages the activation interface and communicating the activation signal to the controller; and
a keyboard input port for receiving a keyboard input signal from an external keyboard and communicating the input signal to the controller.

21. The login device as set forth in claim 20, wherein the activation interface is a touch pad for sensing a presence of a user's finger by measuring a capacitance of a surface of the pad, and for generating the activation signal when the user's finger is present.

22. The login device as set forth in claim 20, wherein the controller interrogates an external identification device by communicating an interrogation signal to the antenna upon simultaneously receiving a predetermined keystroke login signal from the input port and the activation signal from the activation interface.

23. The login device as set forth in claim 1, further comprising a first network port for enabling communications between the login device and a computer network.

24. The login device as set forth in claim 23, further comprising a second network port for enabling communications between an external electronic device and the computer network.

25. The login device as set forth in claim 24, wherein the controller controls communications over the network ports.

26. The login device as set forth in claim 24, further comprising a network interface circuit that controls communications over the network ports.

27. The login device as set forth in claim 1, further comprising
a keyboard input port for receiving a keyboard input signal from an external keyboard and communicating the input signal to the controller; and
a control panel including—
a communication cable for enabling the controller to communicate with components in the control panel,
an activation interface for generating an activation signal when the user engages the activation interface and for communicating the activation signal to the controller, wherein the controller interrogates an external identification device by communicating an interrogation signal to the antenna upon simultaneously receiving the activation signal and a predetermined keystroke login signal from the keyboard input port, and
a control panel housing for containing the antenna and for presenting the activation interface.

28. The login device as set forth in claim 27, wherein the control panel further includes—
a first LED secured to the control panel housing, wherein the controller illuminates the first LED when interrogating the identification tag, and causes the first LED to blink when the controller has received a valid identification number from the identification device and has requested a login script from an external identification server, and
a second LED secured to the control panel housing, wherein the controller illuminates the second LED if no login script is received within a predetermined period of time after requesting a login script from the identification server.

29. The login device as set forth in claim 27, the housing further including an attachment component for securing the housing to a keyboard.

30. A secure automated login device, the device comprising:
a keyboard input port for receiving a keyboard input signal from an external keyboard;
an activation interface for generating an activation signal when a user engages the activation interface;
an antenna for receiving a wireless identification signal;
a controller for receiving the keyboard input signal, for receiving the activation signal, for receiving the identification signal from the antenna, and for generating a keyboard output signal upon receiving the input signal, wherein the keyboard output signal includes login information that corresponds to the identification signal if the input signal is a predetermined login keystroke signal and is received simultaneously with the activation signal, and wherein the keyboard output signal is identical to the keyboard input signal if the input signal is not the predetermined login keystroke signal and received simultaneously with the activation signal; and
a keyboard output port for communicating the keyboard output signal to a keyboard input port of an external computer.

31. The login device as set forth in claim 30, wherein the keyboard input port is a wireless port for receiving wireless input signals from the external keyboard.

32. The login device as set forth in claim 30, wherein the controller interrogates an external identification device by communicating an interrogation signal to the antenna upon simultaneously receiving the predetermined keystroke login signal and the activation signal, and receives the identification signal communicated from the identification device to the antenna.

33. The login device as set forth in claim 32, further comprising a first LED, wherein the controller illuminates the first LED when interrogating the identification device.

34. The login device as set forth in claim 33, wherein the controller determines a user identification number from the identification signal, communicates the identification number to an external identification server, and receives a login script from the server corresponding to the identification number.

35. The login device as set forth in claim 34, wherein the controller communicates with the identification server according to the TCP/IP protocol.

36. The login device as set forth in claim 34, wherein the controller wirelessly communicates with the identification server via the antenna.

37. The login device as set forth in claim 34, wherein the controller encodes the identification number before communicating the number to the identification server, and decodes the login script from an encoded communication received from the identification server.

38. A secure automated login device, the device comprising:
a keyboard input port for receiving a keyboard input signal from an external keyboard;
an antenna for communicating an RF interrogation signal to an electronic identification tag worn by a user and for receiving an RF identification signal from the tag, wherein the antenna extends around the periphery of the external keyboard;
an activation touch pad integral with the login device for sensing the presence of the user's finger by measuring a capacitance of a surface of the pad, and for generating an activation signal when the user's finger is present;
a first network port for enabling communications between the login device and a computer network;
a second network port for enabling communications between an external electronic device and the computer network;
a controller for receiving the keyboard input signal, for receiving the activation signal, for receiving the identification signal from the antenna, for interrogating the identification tag by communicating an interrogation signal to the antenna upon simultaneously receiving the activation signal and a predetermined login keystroke signal from the keyboard input port, for illuminating a first LED when interrogating the identification tag, for receiving the RF identification signal from the antenna and determining an identification number from the signal, for requesting a login script from an external identification server via the first network port upon receiving a valid identification number, for causing the first LED to blink when the device has received the valid identification number and is requesting a login script from the identification server, for receiving the login script via the first network port, for activating a second LED if no login script is received within a predetermined period of time after requesting the login script, and for generating a keyboard output signal that includes the login script;
a keyboard output port for communicating the keyboard output signal to an external computer; and
an attachment component for securing the login device to a keyboard.

39. The login device as set forth in claim 38, wherein the controller generates an output signal that is identical to the input signal if the input signal is not the predetermined login keystroke signal and received simultaneously with the activation signal.

40. A secure automated login device, the device comprising:
a control panel including—
an antenna for communicating an RF signal to an electronic identification tag worn by a user and for receiving an RF signal from the tag,
an activation pad integral with the control panel for sensing the presence of the user's finger by measuring a capacitance of a surface of the pad, and for generating an activation signal when the user's finger is present, and
an attachment component for securing the control panel to a keyboard; and
a base portion including—
a communication cable connecting the base portion and the control panel for enabling communications between components of the control panel and components of the base portion,
a keyboard input port for receiving a keyboard input signal from the keyboard,
a controller for receiving the keyboard input signal, for receiving the activation signal, for interrogating the identification tag by communicating an interrogation signal to the antenna upon simultaneously receiving the activation signal from the activation pad and a predetermined keystroke login signal from the keyboard input port, for receiving the RF identification signal from the antenna and determining an identification number from the signal, for soliciting a login script from an external identification server upon receiving a valid identification number, for receiving the login script, and for generating a keyboard output signal that includes the login script, and
a keyboard output port for communicating the keyboard output signal to an external computer.

41. The login device as set forth in claim 40, wherein the control panel further includes—
a first LED, wherein the controller illuminates the first LED when soliciting the RF identification signal and causes the first LED to blink when the device has received the valid identification number and is soliciting a login script from the identification server, and
a second LED, wherein the controller and activates the second LED if no login script is received within a predetermined period of time after soliciting the login script.

42. The login device as set forth in claim 40, wherein the base portion further includes a network port for enabling communications between the login device and a computer network.

43. A keyboard for automatically logging a user into a computer, the keyboard comprising:
an antenna for receiving a wireless identification signal;
a keypad for generating keystroke signals;
a controller for receiving the keystroke signals, for receiving the identification signal from the antenna, and for generating a keyboard output signal including login information that corresponds to the identification signal;
a memory element for storing the login information and communicating the information to the controller; and
an output port for communicating the keyboard output signal to an external computer.

44. The keyboard as set forth in claim 43, wherein the antenna extends around the periphery of the keyboard.

45. The keyboard as set forth in claim 43, further comprising a network port for allowing the controller to transmit and receive network communications.

46. The keyboard as set forth in claim 45, wherein the controller requests a login script from an identification server via the network port upon receiving a valid identification number from the identification signal.

47. The keyboard as set forth in claim 45, wherein the network port is a wireless network port.

48. The keyboard as set forth in claim 47, wherein the wireless network port uses the antenna to communicate and detect network communications.

49. The keyboard as set forth in claim 47, further comprising a second antenna for communicating and detecting network communications.

50. The login device as set forth in claim 43, further comprising a memory element for storing the login information and communicating the information to the controller.

51. The login device as set forth in claim 50, wherein the memory element includes a removable data storage device.

52. The login device as set forth in claim 51, wherein the removable data storage device includes a flash ROM.

53. The login device as set forth in claim 43, wherein the controller interrogates an external identification device by communicating an interrogation signal to the antenna upon receiving a predetermined keystroke signal.

54. The login device as set forth in claim 53, wherein the controller determines a user identification number from the identification signal, communicates the identification number to an external identification server, and receives a login script from the server corresponding to the identification number.

55. The login device as set forth in claim 54, wherein the controller encodes the identification number before communicating the number to the identification server, and decodes the login script from an encoded communication received from the identification server.

56. A keyboard for automatically logging a user into a computer, the keyboard comprising:
an antenna for communicating an RF interrogation signal to an electronic identification tag worn by a user and for receiving an RF identification signal from the tag, wherein the antenna extends around the periphery of the keyboard;
an activation interface integral with the keyboard for generating an activation signal when engaged by the user;
a controller for receiving the activation signal, for interrogating the identification tag by communicating an interrogation signal to the antenna upon simultaneously receiving the activation signal and a predetermined keystroke login signal, for illuminating a first LED when interrogating the identification tag, for receiving the RF identification signal from the antenna and determining an identification number from the signal, for requesting a login script from an external identification server upon receiving a valid identification number, for causing the first LED to blink when the device has received the valid identification number and is requesting a login script from the identification server, for receiving the login script, for activating a second LED if no login script is received within a predetermined period of time after soliciting the login script, and for generating a keyboard output signal that includes the login script;
a first network port for enabling communications between the keyboard and a computer network;
a second network port for enabling communications between an external electronic device and the computer network; and
an output port for communicating the keyboard output signal to a keyboard input port of an external computer.

57. An automated user verification system, the system comprising:
a keyboard for generating keystroke signals;
an identification tag worn by a user for storing and wirelessly communicating an identification number in response to an interrogation signal;
a registration device for acquiring biometric information from the user, for acquiring the identification number from the electronic identification tag worn by the user;
an identification server for receiving the biometric information and the identification number from the registration device, for receiving a login script request including the identification number, and for generating a login script including a username and a password based on the identification number; and
a secure automated login device for interrogating the identification tag upon receiving a predetermined login keystroke signal from the keyboard, for receiving the identification number from the identification tag, for communicating the identification number to the identification server and receiving the login script from the identification server, and for communicating the login script to a host computer.

58. A method of automatically logging a user into a computer system comprising the steps of:
(a) receiving a wireless identification signal;
(b) generating computer login information with a digital controller, wherein the login information corresponds to the identification signal; and
(c) communicating the login information to a keyboard input port of a computer.

59. The method as set forth in claim 58, further comprising the steps of:
(d) receiving a predetermined keystroke login signal from a keyboard;
(e) interrogating an external identification device by wirelessly communicating an interrogation signal to the device upon receiving the login signal; and
(f) receiving the wireless identification signal from the identification device.

60. The method as set forth in claim 59, further comprising the steps of:
(g) receiving an activation signal from an activation interface when a user engages the activation interface; and
(h) interrogating the external identification device by wirelessly communicating the interrogation signal to the device only if the keystroke login signal and the activation signal are received simultaneously.

61. The method as set forth in claim 60, further comprising the steps of:
(i) determining an identification number from the identification signal;
(j) communicating the identification number to an identification server;
(k) receiving a login script from the identification server; and
(l) communicating the login script to the computer.

62. The method as set forth in claim 61, further comprising the steps of:
(m) encoding the identification number before communicating it to the identification server;
(n) receiving an encoded login script from the identification server; and
(o) decoding the login script.

63. A method of automatically logging a user into a computer system comprising the steps of:
(a) receiving a predetermined keyboard signal from a keyboard;
(b) receiving an activation signal from an activation interface when a user engages the activation interface;
(c) interrogating an external identification device by wirelessly communicating an interrogation signal to the device if the keyboard signal and the activation signal are received simultaneously;
(d) illuminating a first LED upon communicating the interrogation signal;
(e) receiving an identification signal from the identification device;
(f) causing the first LED to blink upon receiving the identification signal;
(g) determining an identification number from the identification signal;
(h) encoding the identification number;
(i) communicating the encoded identification number to an identification server;
(j) illuminating a second LED if a login script is not received from the identification server;
(k) receiving an encoded login script from the identification server;
(l) decoding the login script; and
(m) communicating the decoded login script to a computer.
